(19) United States
(12) Patent Application Publication
(10) Pub. No.: US 2010/0140222 A1
(43) Pub. Date: Jun. 10, 2010

(54) FILLED POLYMER COMPOSITION FOR ETCH CHAMBER COMPONENT

(76) Inventors: Jennifer Y. Sun, Mountain View, CA (US); Ren-Guan Duan, Fremont, CA (US); Senh Thach, Union City, CA (US); Li Xu, San Jose, CA (US)

Correspondence Address: APPLIED MATERIALS/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/632,712

(22) Filed: Dec. 7, 2009

Related U.S. Application Data
(60) Provisional application No. 61/121,490, filed on Dec. 10, 2008.

(51) Int. Cl. C08K 3/10; C08K 3/16; C08K 3/28; C08K 3/08; C08K 3/34; C08K 3/22; B32B 7/12; C23F 1/02; C23F 1/08

(52) U.S. Cl. 216/67; 524/408; 524/413; 524/428; 524/441; 524/443; 524/403; 428/356; 156/345.34; 156/345.51

(57) ABSTRACT

A filled polymer composition having improved plasma resistance is disclosed. The composition includes a particle filler dispersed in a polymer matrix. The particle filler can be Nb₂O₅, YF₃, AlN, SiC or Si₃N₄ and rare earth oxides. In an embodiment, the composition is utilized as a bonding adhesive for electrostatic chuck, bonding adhesive for shower head, bonding adhesive for liner, sealing material, O-ring, or plastic component.

### RELATED APPLICATIONS

The present patent application hereby claims the priority benefit of U.S. Provisional Patent Application No. 61/121,490, filed Dec. 10, 2008.

### BACKGROUND

1. Field

Embodiments of the present invention relate to the field of filled polymer materials. More particularly, embodiments of the present invention related to a filled polymer composition for use in etch chamber components.

2. Background Information

Polymer materials used in etch chamber components are exposed to plasmas within the etch chamber during both substrate etching and chamber cleaning processes. For example, plasma etch residues and byproducts formed on chamber components can pose a chronic problem, and therefore the etch chamber is periodically cleaned to prevent process drift and particle generation. As a result, the polymer materials can themselves become a source of particle adders and also must be periodically replaced because they are eroded by the various etching and cleaning plasmas.

### SUMMARY

Embodiments of the present invention disclose a filled polymer composition including a particle filler dispersed in a polymer matrix. The particle filler can be Nb₂O₅, YF₃, AlN, Al, SiC, Si₃N₄, rare earth oxides, and combinations thereof. The filled polymer composition can be utilized in any chamber or service environment exposed to various plasmas to prolong the service life, to improve the application temperature, to advance process uniformity, to decrease the amount of formed particles, and to decrease metal contamination. In an embodiment, the filled polymer composition is utilized as a bonding adhesive for an electrostatic chuck, bonding adhesive for a shower head, bonding adhesive for a liner, a sealing material, an O-ring, or a plastic component.

### BRIEF DESCRIPTION OF THE DRAWINGS

FIG. 1A and FIG. 1B are isometric view illustrations of an etch chamber.

FIG. 1C includes an overhead view illustration and close-up isometric view illustration of a showerhead backside and O-ring.

FIG. 1D is an overhead view illustration of an electrostatic chuck backside.

FIG. 2A-FIG. 2B are illustrations of the surface morphology of the erosion surface of an adhesive exposed to a CH₄/CHF₃ plasma for 5 RF hours.

FIG. 3A-FIG. 3B are illustrations of the surface morphology of the erosion surface of an adhesive exposed to a HBr/Cl₂/CF₄/O₂ plasma for 6.5 RF hours.

FIG. 4A-FIG. 4B are illustrations of the surface morphology of the erosion surface of an adhesive exposed to a SiCl₄ plasma for 12 RF hours.

### DETAILED DESCRIPTION

Embodiments of the present invention disclose a filled polymer composition and applications of the filled polymer composition in plasma chamber components.

Various embodiments described herein are described with reference to figures. In the following description, numerous specific details are set forth, such as specific configurations, compositions, and processes, etc., in order to provide a thorough understanding of the present invention. However, certain embodiments may be practiced without one or more of these specific details, or in combination with other known methods and configurations. In other instances, well-known processes and manufacturing techniques have not been described in particular detail in order to not unnecessarily obscure the present invention. Reference throughout this specification to “one embodiment” or “an embodiment” means that a particular feature, configuration, composition, or characteristic described in connection with the embodiment is included in at least one embodiment of the invention. Thus, the appearances of the phrase “in one embodiment” or “an embodiment” in various places throughout this specification are not necessarily referring to the same embodiment of the invention. Furthermore, the particular features, configurations, compositions, or characteristics may be combined in any suitable manner in one or more embodiments.

Embodiments of the invention disclose a filled polymer composition including a particle filler dispersed in a polymer matrix. In an embodiment, the particle filler has an average particle size of 10 nm-10 μm, and can be a rare earth oxide, Nb₂O₅, YF₃, AlN, SiC, Si₃N₄, and combinations thereof. In another embodiment, the particle filler can be a metal such as Al powder of the same average particle size. The particle filler is tightly combined with the polymer matrix to provide a composition with improved properties including excellent plasma resistance, material structure stability (low outgassing), high temperature application, improved thermal properties (thermal conductivity and thermal expansion), advanced mechanical properties (elongation, elastic modulus, lap share, tensile strength) and much reduced particle generation potential. The filled polymer composition can be utilized in any chamber or service environment exposed to various plasmas to prolong the service life, to improve the application temperature, to advance process uniformity, to decrease the amount of formed particles, and to decrease metal contamination. In an embodiment, the filled polymer composition is utilized as a bonding adhesive for electrostatic chuck, a bonding adhesive for shower head, a bonding adhesive for liner, a sealing material, an O-ring, or a plastic component.

As used herein, the term “rare earth oxide” means an oxide of the rare earth elements in the Periodic Table of Elements called the Lanthanide Series that runs from atomic number 57 to 71, and additionally elements yttrium #39 and scandium #21 because they share similar properties to the elements of the Lanthanide Series. For example, the particle filler can be a rare earth oxide such as, but not limited to, Y₂O₃, Sc₂O₃, Er₂O₃, Nd₂O₃, Sm₂O₃ and Yb₂O₃.

The polymer matrix can be a variety of materials. For example, the polymer matrix may be fluorinated carbon based, polyimide based, ether ketone based, and silicon based including partially and fully fluorinated silicon. In an embodiment, the polymer matrix is a perfluoroelastomer, thermosetting silicone, a thermoplastic acrylic, or poly(etheretherketone) (PEEK).

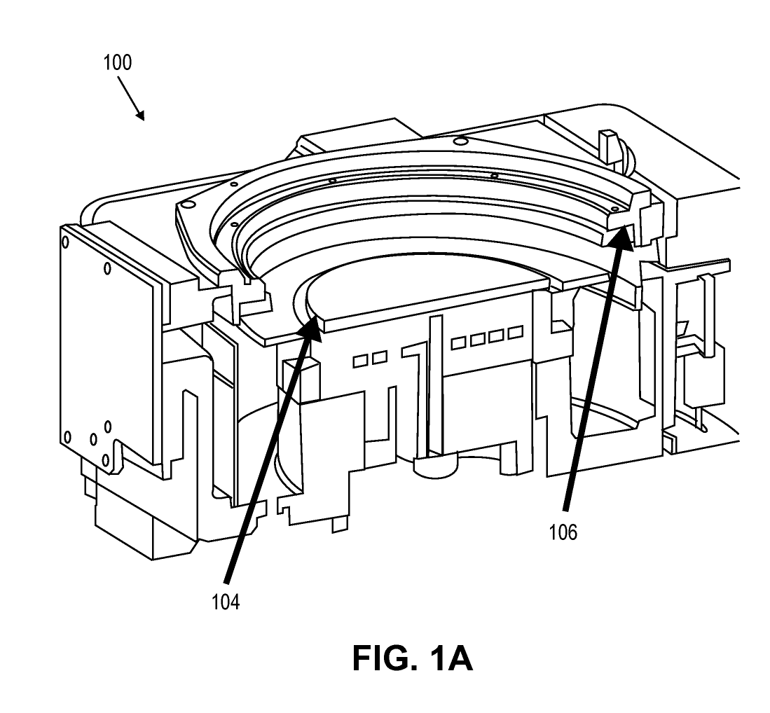

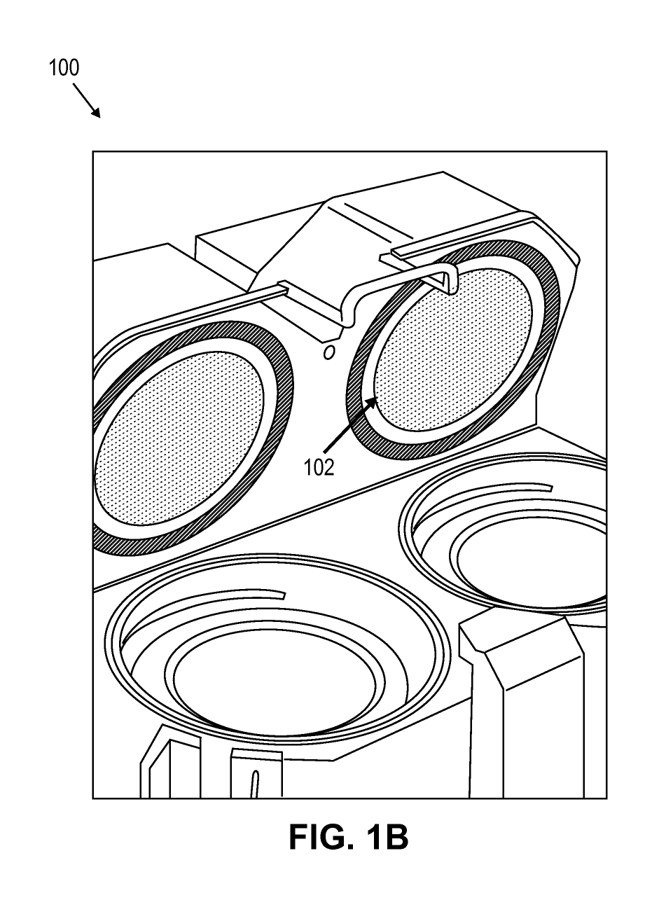

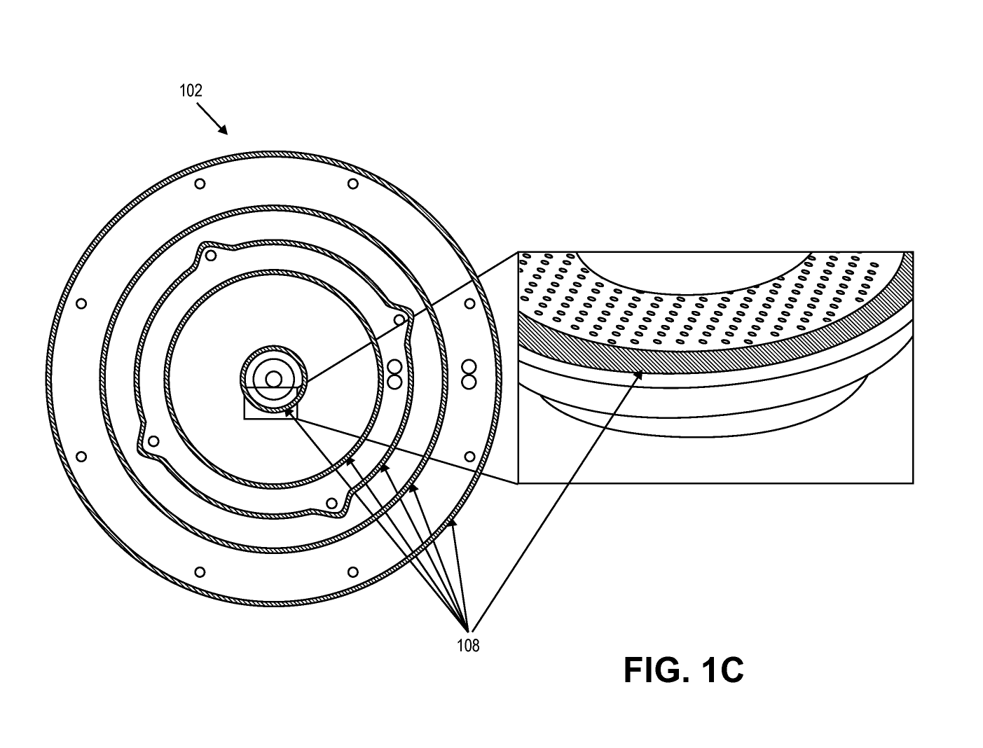

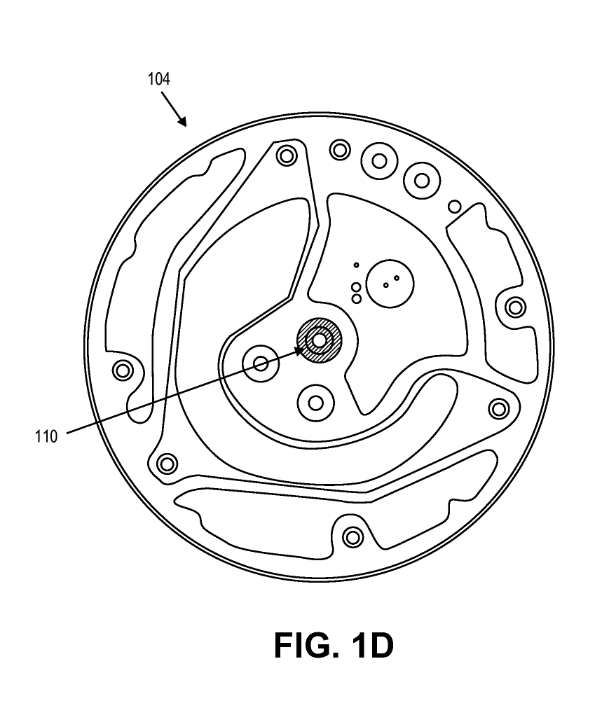

FIG. 1A and FIG. 1B are illustrations of an etch chamber in accordance with an embodiment of the invention. For example, the chamber illustrated in FIG. 1A may be a CENTURA ENABLER ETCH™ chamber available from Applied Materials, Inc. of Santa Clara, Calif. For example, the chamber illustrated in FIG. 1B may be a PRODUCER ETCH™ chamber available from Applied Materials, Inc. of Santa Clara, Calif. As shown in FIG. 1A and FIG. 1B, the etch chamber 100 can include a chamber lid configured to provide plasma or energy from a plasma generator (not shown) and gas from the process gas source a gas conduit (not shown). A gas shower head 102 may be bonded to the chamber lid utilizing an adhesive comprising a filled polymer composition in accordance with embodiments of the invention. The base of the chamber contains an electrostatic chuck 104 which is attached to a power source (not shown). The electrostatic chuck 104 can be bonded to a support utilizing an adhesive comprising a filled polymer composition. Similarly a chamber liner 106 can be bonded to the chamber utilizing an adhesive comprising a filled polymer composition in accordance with embodiments of the invention.

In an embodiment where the filled polymer composition is employed as a bonding adhesive, for example, for an electrostatic chuck, shower head, and/or liner, it may be preferable to adjust the materials properties of the filled polymer composition to minimize the coefficient of thermal expansion (CTE) mismatch between a metal and a ceramic. In an embodiment, a higher tensile elongation %, higher tensile strength, and lower Young's Modulus are desirable for electrostatic chuck bonding application. For example, the filled polymer composition may exhibit a tensile elongation % above 190%, a tensile strength above 2.2 MPa, and Young's Modulus below 2.0 MPa. In an embodiment, the filled polymer composition may exhibit a tensile elongation % above 105%, and Young's Modulus below 3.8 MPa.

The filled polymer composition is not limited to adhesive applications. In an embodiment, the filled polymer composition can be a seal such as an O-ring. FIG. 1C includes an overhead view illustration and close-up isometric view illustration of a showerhead backside and O-ring. In an embodiment, the filled polymer composition is an O-ring 108 located on a showerhead 102.

In an embodiment, the filled polymer composition can be an insert plastic part such as a cathode insulator. FIG. 1D is an overhead view illustration of an electrostatic chuck backside. In an embodiment, the filled polymer composition is a cathode insulator 110 located on an electrostatic chuck 104. In such an embodiment, tensile elongation % may not be a necessary property, and instead tensile strength is more important for a cathode insulator or similar high performance plastic application.

The filled polymer composition can be implemented into a variety of critical etch chamber components to prolong the service life, to improve the application temperature, to advance process uniformity, to decrease the amount of formed particles, and to reduce metal contamination. In addition, the filled polymer composition can be applied to other service environments, not limited to plasma chambers, where the excellent plasma resistance performance and adjustable materials properties are required.

The filled polymer composition can be prepared utilizing a number of known techniques depending upon application. In an embodiment, the filled polymer composition can be prepared by adding a particle filler to a solution including a dissolved polymer composition. The particle filler can be uniformly dispersed in the solution utilizing a dispersing agent, cast, cured, and post-cure baked as is known in the art. In another embodiment, particulate polymer and particle filler can be physically mixed together by stirring or ball milling as is known in the art.

In one aspect, embodiments of the invention disclose a filled polymer composition in which the particle size of the particle filler can be varied to obtain the required materials properties. In an embodiment, the particle filler has an average particle size of 10 nm-10 μm. In an embodiment, the particle filler has a particle size small enough that the particle itself does not become a contaminant. For example, the particle filler may have a particles size of less than 1 μm. It has been found that below approximately 10 nm particles can be difficult to evenly disperse. Larger particles are beneficial when matching of thermal conductivity of the filled polymer composition to another material is desired. However, above approximately 10 μm the particle filler can act as a physical barrier to outgassing during post-cure baking of the filled polymer composition. Consequently, the filled polymer composition may subsequently outgas into the plasma chamber during operation if the particle filler has a particle size greater than 10 μm.

In one aspect, embodiments of the invention disclose a filled polymer composition in which the volume % of the particle filler can be varied to obtain the required materials properties. In one embodiment, the filled polymer composition includes 50%-75% particle filler by volume. Maintaining the volume density of the particle filler is particularly beneficial for applications where the filled polymer composition is exposed to significant plasma etching, such as, but not limited to, a bonding adhesive for a shower head, electrostatic chuck and/or liner. The specific volume composition obtains the synergetic effect of changing the characteristic etch rate of the entire filled polymer composition. While individually, the polymer matrix and particle filler possess different characteristic etch rates to specific plasma chemistries, when the filled polymer composition includes 50%-75% particle filler by volume the etch rate of the entire filled polymer composition is improved. This is accomplished by controlling the volume density of particles such that the particles touch one another, and can further bond or coalesce when exposed to a plasma process such as a plasma etching or cleaning process.

Plasma chamber components comprising a filled polymer composition in accordance with embodiments of the invention may demonstrate increased plasma resistance which can be measured by surface erosion and surface morphology. Table I includes normalized surface erosion data of filled polymer compositions for adhesive applications in accordance with the present invention, compared to the base polymer composition of thermosetting silicone and a thermoplastic acrylic polymer filled with Al mesh and TiB₂ filler.

TABLE I
Normalized Surface Erosion

| | | | Al mesh with | Y₂O₃ filled | AlN filled | |
|---|---|---|---|---|---|---|
| | | | TiB₂ filled | (380 nm) | (560 nm) | BN filled |
| | | Thermosetting | thermoplastic | thermosetting | thermosetting | thermosetting |
| Application | Plasma | silicone | acrylic | silicone | silicon | silicone |
| Adhesive | CF₄/CHF₃ | ~2 | ~20 | 1 | — | ~2 |
| | Plasma | | | | | |
| | 5 RF hrs | | | | | |
| Adhesive | HBr/Cl₂/CF₄/O₂ | ~22 | ~20 | 1 | ~2.5 | — |
| | Plasma | | | | | |
| | 6.5 RF hrs | | | | | |
| Adhesive | SiCl₄ Plasma | ~2.5 | — | 1 | ~1.5 | — |
| | 12 RF hrs | | | | | |

As shown in Table I, an embodiment in which an adhesive comprises a filled polymer composition containing 50%-75% by volume Y₂O₃ filler particles with an average particle size of 380 nm embedded in a thermosetting silicone matrix exhibits the lowest normalized surface erosion for the three plasma conditions. For example, when exposed to a CH₄/CHF₃ plasma for 5 RF hours, thermosetting silicone experiences 2 times, and Al mesh with TiB2 filled thermoplastic acrylic experiences 20 times the amount of surface erosion. Fluorine chemistries such as CF₄/CHF₃ are etch chemistries often utilized in dielectric substrate etching. HBr/Cl₂/CF₄/O₂ chemistries are etch chemistries often utilized in conductive substrate etching. O₂ and SiCl₄ chemistries are etch chamber clean chemistries. SiCl₄ in particular is utilized as an etch chamber clean chemistry to remove AlF contamination from chamber components which forms during dielectric and conductive surface etching.

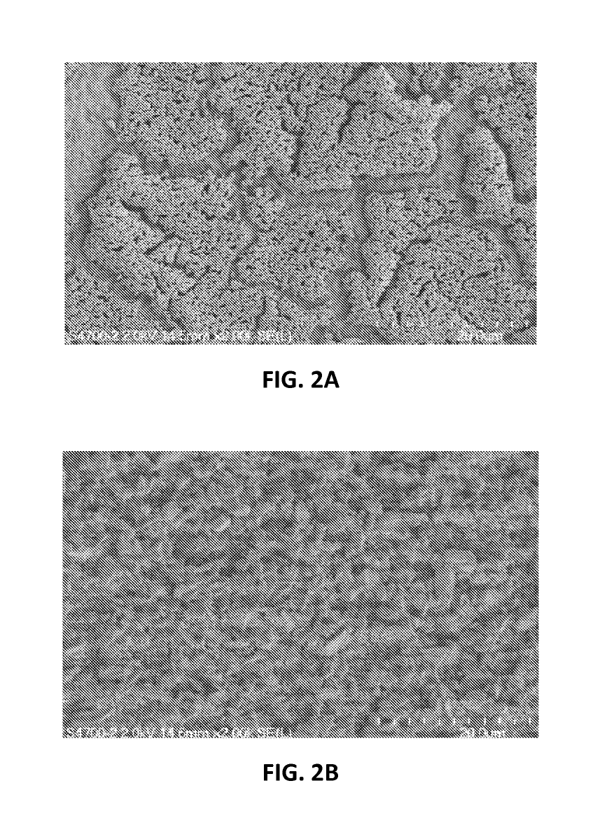

FIG. 2A-FIG. 2B are illustrations of the surface morphology of the erosion surface of an adhesive exposed to a CH₄/CHF₃ plasma for 5 RF hours. As shown in FIG. 2A, a thermosetting silicone polymer matrix results in an erosion surface with a course surface morphology. FIG. 2B is a filled polymer composition in accordance with embodiments of the present invention including a thermosetting silicone polymer matrix and a Y₂O₃ particle filler. As shown in FIG. 2B, the surface morphology is largely improved after fluorine plasma etch, which reduces metal contamination and particle counts.

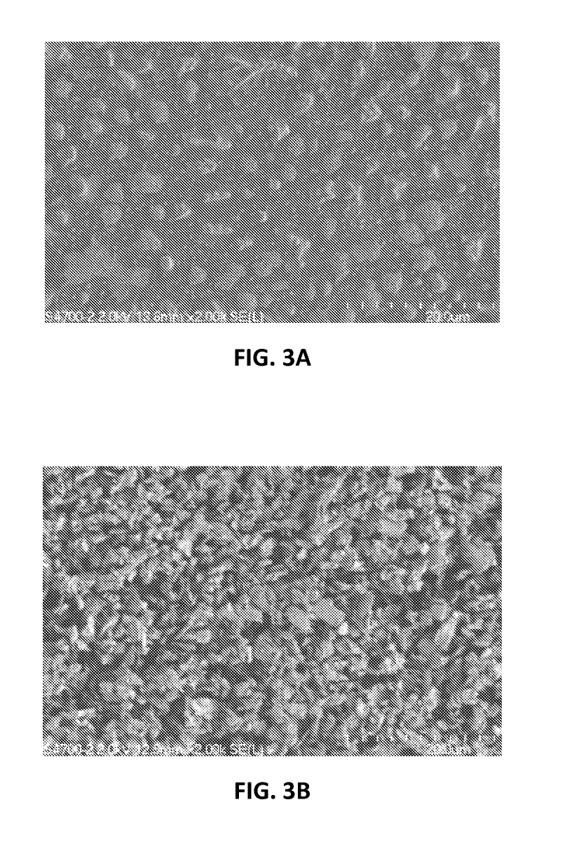

FIG. 3A-FIG. 3B are illustrations of the surface morphology of the erosion surface of an adhesive exposed to a HBr/Cl₂/CF₄/O₂ plasma for 6.5 RF hours. As shown in FIG. 3A, a thermosetting silicone polymer matrix results in an erosion surface with a course surface morphology. FIG. 3B is a filled polymer composition in accordance with embodiments of the present invention including a thermosetting silicone polymer matrix and a Y₂O₃ particle filler. As shown in FIG. 3B, only the Y₂O₃ particle filler was left on the surface and the thermosetting silicone polymer matrix was etched, meaning that the Y₂O₃ particle filler played a major role in improving the plasma resistance.

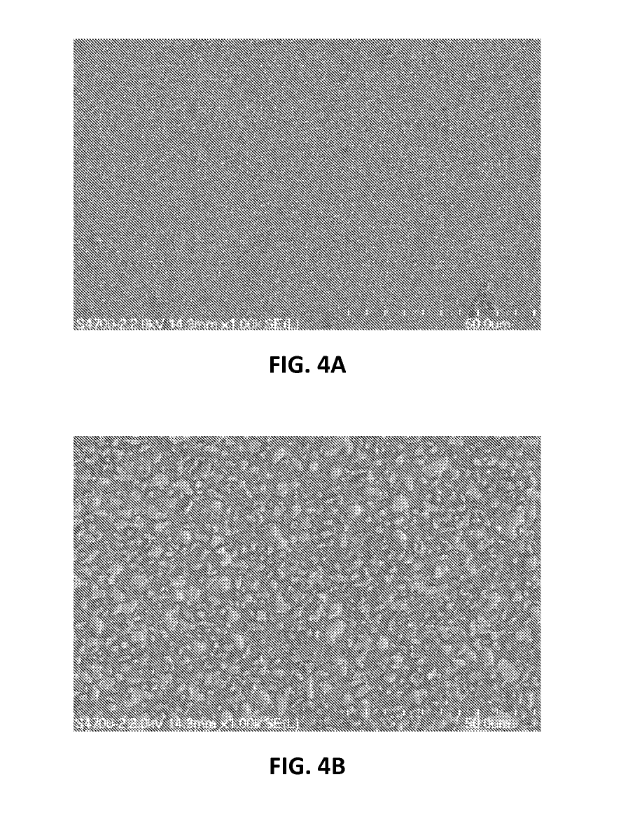

FIG. 4A-FIG. 4B are illustrations of the surface morphology of the erosion surface of an adhesive exposed to a SiCl₄ plasma for 12 RF hours. A thermosetting silicone polymer matrix is shown in FIG. 4A. FIG. 4B is a filled polymer composition in accordance with embodiments of the present invention including a thermosetting silicone polymer matrix and a Y₂O₃ particle filler. As shown in FIG. 4B, the Y₂O₃ particle filler was exposed and most of the surface thermosetting silicone polymer matrix was etched, meaning that the Y₂O₃ particle filler played a major role in improving the plasma resistance.

In another embodiment, the filled polymer composition of the present invention is implemented in a plasma chamber as an O-ring. For example, the filled polymer composition can contain approximately 15% by volume Y₂O₃ particle filler in a perfluoroelastomer polymer matrix, which exhibits approximately 4 times less erosion than an unfilled perfluoroelastomer polymer matrix when exposed to a CF₄ plasma, approximately 7 times less erosion when exposed to an O₂ plasma, and approximately 5 times less erosion when exposed to a CF₄/O₂ plasma. The improved plasma resistance improves the lifetime, reduces contamination, and particle generation.

In another embodiment, the filled polymer composition of the present invention is implemented in a plasma chamber as a high performance plastic, such as a cathode insulator. For example, the filled polymer composition includes Y₂O₃ particle filler in a PEEK polymer matrix. In such an application, the particle filler improves the tensile strength, tensile modulus, flexural modulus, and surface resistivity compared to an unfilled PEEK cathode insulator. In addition, surface erosion is improved over 100 times compared to an unfilled PEEK composition when exposed to an O₂ plasma for 14 RF hours.

In the foregoing specification, various embodiments of the invention have been described. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A composition comprising:
a polymer matrix;
a particle filler dispersed in the polymer matrix;
wherein the particle filler is selected from the group consisting of Nb₂O₅, YF₃, MN, Al, SiC, Si₃N₄, rare earth oxides, and combinations thereof.

2. The composition of claim 1, wherein the particle filler is Y₂O₃.

3. The composition of claim 1, wherein the particle filler has an average particle size less than 10 microns.

4. The composition of claim 1, wherein composition comprises 50%-75% particle filler by volume.

5. The composition of claim 1, wherein the polymer matrix is selected from the group consisting of fluorinated carbon based, polyimide based, ether ketone based and silicon based.

6. The composition of claim 1, in the form of an O-ring.

7. The composition of claim 1, in the form of an adhesive.

8. The composition of claim 7, wherein the adhesive is bonded to an item selected from the group consisting of an electrostatic chuck, a shower head and a chamber liner.

9. The composition of claim 1, in the form of a cathode insulator.

10. A method of operating an etch chamber comprising:
striking a plasma; and
exposing a chamber component to the plasma;
wherein the chamber component comprises a polymer matrix and a particle filler dispersed in the polymer matrix, the particle filler selected from the group consisting of Nb₂O₅, YF₃, AN, Al, SiC, Si₃N₄, rare earth oxides, and combinations thereof.

11. The method of claim 10, wherein the plasma comprises a cleaning chemistry selected from the group consisting of O₂ and SiCl₄.

12. The method of claim 10, wherein the plasma comprises a conductive surface etch chemistry selected from the group consisting of HBr, Cl₂, CF₄ and O₂.

13. The method of claim 10, wherein the plasma comprises a dielectric substrate etch chemistry selected from the group consisting of CF₄ and CHF₃.

14. The method of claim 10, wherein the filled polymer matrix is selected from the group consisting of an O-ring, an adhesive and a cathode insulator.

15. The method of claim 11, wherein the plasma removes AlF contamination from the etch chamber.

16. An etch chamber comprising:
a shower head;
an electrostatic chuck;
a cathode;
a liner; and
a chamber component comprising a polymer matrix and a particle filler dispersed in the polymer matrix, the particle filler selected from the group consisting of Nb₂O₅, YF₃, AN, Al, SiC, Si₃N₄, rare earth oxides, and combinations thereof.

17. The etch chamber of claim 16, wherein the chamber component is an adhesive.

18. The etch chamber of claim 16, wherein the chamber component is an O-ring.

19. The etch chamber of claim 16, wherein the chamber component is a cathode insulator.

20. The etch chamber of claim 16, wherein the particle filler is Y₂O₃.
